(19) United States
(12) Patent Application Publication
(10) Pub. No.: US 2012/0175425 A1
(43) Pub. Date: Jul. 12, 2012

(54) SYSTEMS AND METHODS FOR CONTROLLING A SPRINKLER SYSTEM BASED ON SENSOR INFORMATION

(75) Inventors: Bradley D. Evers, Satellite Beach, FL (US); Michael R. Winters, West Melbourne, FL (US); Kerley Prudhomme, Silver Spring, MD (US); Cara Evers, Satellite Beach, FL (US)

(73) Assignee: HARRIS CORPORATION, Melbourne, FL (US)

(21) Appl. No.: 13/004,156

(22) Filed: Jan. 11, 2011

(51) Int. Cl. B05B 9/00; B05B 15/00

(52) U.S. Cl. 239/1; 239/71

(57) ABSTRACT

Systems (100) and methods (800) for controlling a sprinkler system. The methods involve connecting a Sensor-Based Control System (SBCS) between a Sprinkler Control System (SCS) and at least one valve (106₁, 106₂, . . . , 106_{N}) and/or pump (109). A user-interactive session is performed to select a threshold value (THR) for a relative moisture content parameter. A Sensor Device (SD) measures a moisture content of soil contained in a tract of land (110). Thereafter, Measurement Data (MD) is communicated from SD (112₁, . . . , 112₅) to SBCS. MD includes information defining an amount of moisture content measured by SD. At SBCS, it is determined if the amount of moisture content exceeds THR. If the amount of moisture content does not exceed THR, an electrical connection is established between SCS and the valve. An electrical connection can additionally or alternatively be established between SCS and the pump.

### BACKGROUND OF THE INVENTION

1. Statement of the Technical Field

The inventive arrangements relate to sprinkler systems, and more particularly to systems and methods for controlling the operations of the sprinkler system.

2. Description of the Related Art

There are various conventional Sensor-Based Sprinkler (SBS) systems known in the art. One such conventional SBS system is a Rain Sensor Based Sprinkler (RSBS) system. The RSBS system comprises a rain sensor that is an electromechanical component configured for collecting fallen rain. The RSBS system controls the operation of sprinklers based on the amount of rain collected by the rain sensor. For example, if one inch (1″) of rain is collected by the rain sensor, then the RSBS system will prevent or stop water from flowing from a water source to the sprinklers. In contrast, if a quarter inch (¼″) of rain is collected by the rain sensor, then the RSBS system will send a control signal to a valve for allowing water to flow from the water source to the sprinklers.

Despite the advantages of the RSBS system, it suffers from certain drawbacks. For example, the moving parts of the rain sensor are susceptible to dirt, insects and debris. If dirt, insects and/or debris collect in a rain collection container of the rain sensor, then the rain sensor may fail or provide inaccurate measurements of the amount of fallen rain. Also, the desired moisture level of soil is difficult to calibrate based on the information received from the rain sensor. Furthermore, the RSBS system does not provide a way for users to define parameters for controlling operations of the RSBS system so that the amount of water supplied to an area of a tract of land is optimized for specific types of soil and/or plants.

A second conventional SBS system is described in U.S. Pat. No. 7,658,336 to Kates (“Kates”). The SBS system of Kates includes moisture sensors and fire sensors. The moisture sensors are configured to measure the moisture content of soil. The fire sensors are configured to measure temperature. The moisture and temperature sensors are also configured to communicate information representing values of the measured parameters to a central control system over a wired or wireless communications link. Based on the moisture data, the central control system decides how much water to put down in one or more zones of a tract of land. The central control system also activates water control valves, which permits water from a water supply to flow through the water control valves. Further, based on the moisture data or temperature data, the central control system configures the spray pattern of the sprinklers.

Despite the advantages of the SBS system of Kates, it suffers from certain drawbacks. For example, the central control system of Kates is undesirably inoperable with conventional sprinkler controllers. As such, conventional sprinkler controllers must be replaced with the central control system of Kates. This replacement is undesirable since sprinkler controllers are somewhat expensive to purchase and install. The central control system of Kates also does not allow a user to customize parameters (e.g., a moisture content parameter and a temperature parameter) of a software application installed on the central control system.

A third conventional SBS system is described in U.S. Pat. No. 4,852,802 to Iggulden et al. (“Iggulden”). The SBS system of Iggulden comprises a controller and a moisture sensor for sensing moisture content of soil. The moisture sensor has a user interface for facilitating the selection of the type of plant being watered. During operation, the moisture sensor measures the moisture content of soil. Thereafter, the moisture sensor uses the measured value to determine whether a local area requires additional water to achieve the conditions that the inputted plant type parameter dictates. When the conditions have been met, the moisture sensor communicates a signal to the controller for causing the water flow to sprinklers to be stopped by closing a valve.

Despite the advantages of the conventional SBS system of Iggulden, it suffers from certain drawbacks. For example, the controller of Iggulden is inoperable with conventional sprinkler controllers. As such, conventional sprinkler controllers must be replaced with the controller of Iggulden. The controller replacement is undesirable since sprinkler controllers are somewhat expensive to purchase and install. Also, the controller of Iggulden is absent of a user interface to allow a user to customize parameters (e.g., a moisture content parameter and a temperature parameter) for software applications installed thereon. Furthermore, the moisture sensors of Iggulden are relatively expensive as compared to other types of moisture sensors.

### SUMMARY OF THE INVENTION

Embodiments of the present invention generally concern implementing systems and methods for controlling a sprinkler system. The methods involve connecting a Sensor-Based Control System (SBCS) between an output of a Sprinkler Control System (SCS) and at least one actuator (e.g., a valve and/or a pump). Thereafter, a user-interactive session is performed to select a first threshold value for a relative moisture content parameter of a software application installed on the SBCS. The first threshold value represents a desired maximum amount of moisture content of a tract of land (e.g., a yard).

The methods also involve measuring, by at least one sensor device, a moisture content of soil contained in the tract of land. Subsequent to taking measurements, the sensor device communicates measurement data to the SBCS. The data communication is preferably achieved using a wireless communications link. The measurement data includes information defining the amount of moisture content of the soil. At the SBCS, it is determined whether the amount of moisture content of the soil exceeds the first threshold value. If the amount of moisture content of the soil does not exceed the first threshold value, then an electrical connection is established between the SCS and the actuator (e.g., valve(s) and/or pump). Alternatively or additionally, an electrical connection is established between the SCS and the actuator (e.g., valve(s) and/or pump). The electrical connections are achieved by closing at least one switch of the SBCS. Also, an indicator is output from the SBCS indicating that the amount of moisture content of the soil does not exceed the first threshold value. The indicator includes, but is not limited to, light and/or sound.

According to an aspect of the present invention, the user-interactive session is further performed to select one or more values for a temperature parameter of the software application. The values can represent a minimum temperature at which the sprinkler system is to operation or a range of temperatures in which the sprinkler system is to operate. In this scenario, the sensor device measures a temperature of a surrounding environment. Thereafter, the sensor device communicates measurement data to the SBCS. The measurement data includes information defining the temperature measured by the sensor device. At the SBCS, it is determined whether the temperature measured by the sensor device exceeds a second threshold value or falls within the range of temperatures. If (a) the temperature measured by the sensor device exceeds the second threshold value or falls within the range of temperatures and (b) the amount of moisture content of the soil does not exceed the first threshold value, then an electrical connection is established between the SCS and the actuator (e.g., valve(s) and/or pump).

According to another aspect of the present invention, the SBCS determines whether it is predicted to rain at a particular location. If it is predicted to rain at the particular location, then the SBCS disables or postpones the establishment of the electrical connection(s). In this scenario, the SBCS can determine the particular location using GPS location information or information (e.g., in IP address) provided by a user during the user-interactive session.

### BRIEF DESCRIPTION OF THE DRAWINGS

Embodiments will be described with reference to the following drawing figures, in which like numerals represent like items throughout the figures, and in which:

FIG. 1A is a schematic illustration of an exemplary sprinkler system that is useful for understanding the present invention.

FIG. 1B is a more detailed block diagram of the control system of FIG. 1A that is useful for understanding the present invention.

FIG. 2 is detailed block diagram of an exemplary sensor device that is useful for understanding the present invention.

FIG. 3 is a schematic illustration of an exemplary moisture sensor that is useful for understanding the present invention.

FIG. 4 is a block diagram of an exemplary sensor-based control system that is useful for understanding the present invention.

FIG. 5 is a block diagram of an exemplary switch circuit that is useful for understanding the present invention.

FIG. 6 is a schematic illustration of a first exemplary interface selector control of a sensor-based control system that is useful for understanding the present invention.

FIG. 6 is a schematic illustration of a second interface selector control of a sensor-based control system that is useful for understanding the present invention.

FIGS. 8A-8C collectively provide a flow diagram of an exemplary method for controlling a sprinkler system that is useful for understanding the present invention.

FIG. 9 is a flow diagram of exemplary method for accessing and analyzing data recorded by a sensor-based control system that is useful for understanding the present invention.

### DETAILED DESCRIPTION

The present invention is described with reference to the attached figures, wherein like reference numbers are used throughout the figures to designate similar or equivalent elements. The figures are not drawn to scale and they are provided merely to illustrate the present invention. Several aspects of the invention are described below with reference to example applications for illustration. It should be understood that numerous specific details, relationships, and methods are set forth to provide a full understanding of the invention. One having ordinary skill(s) in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

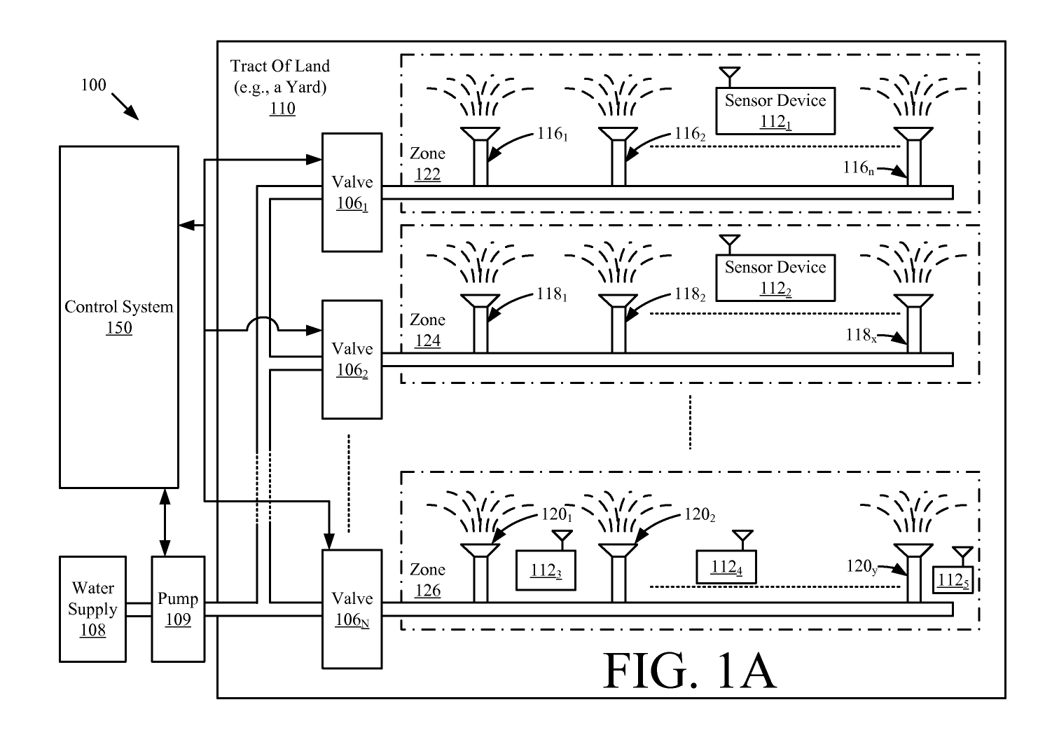

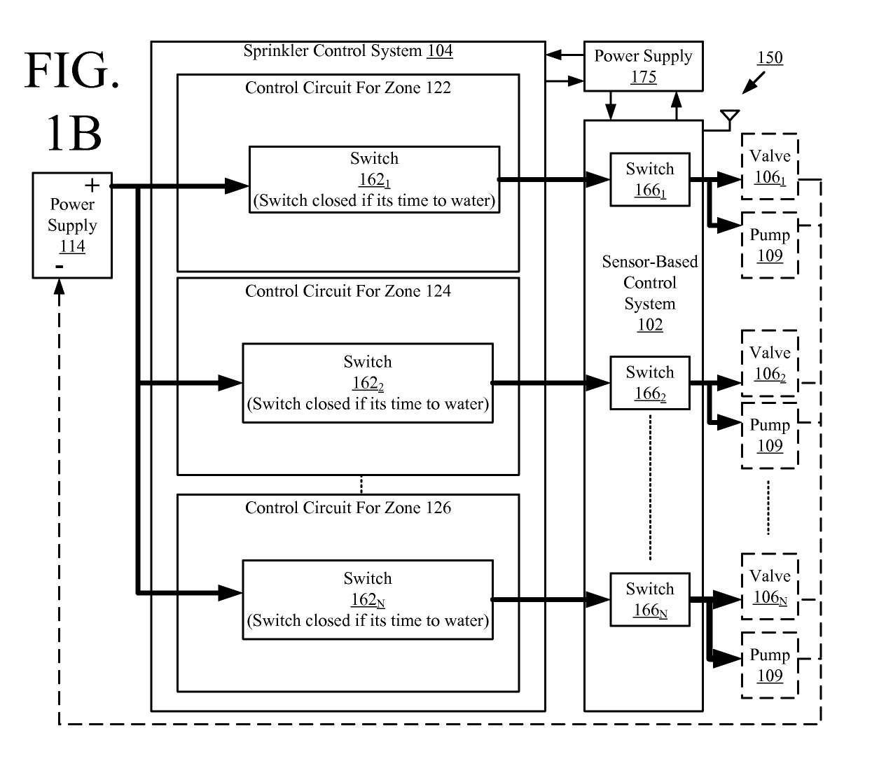

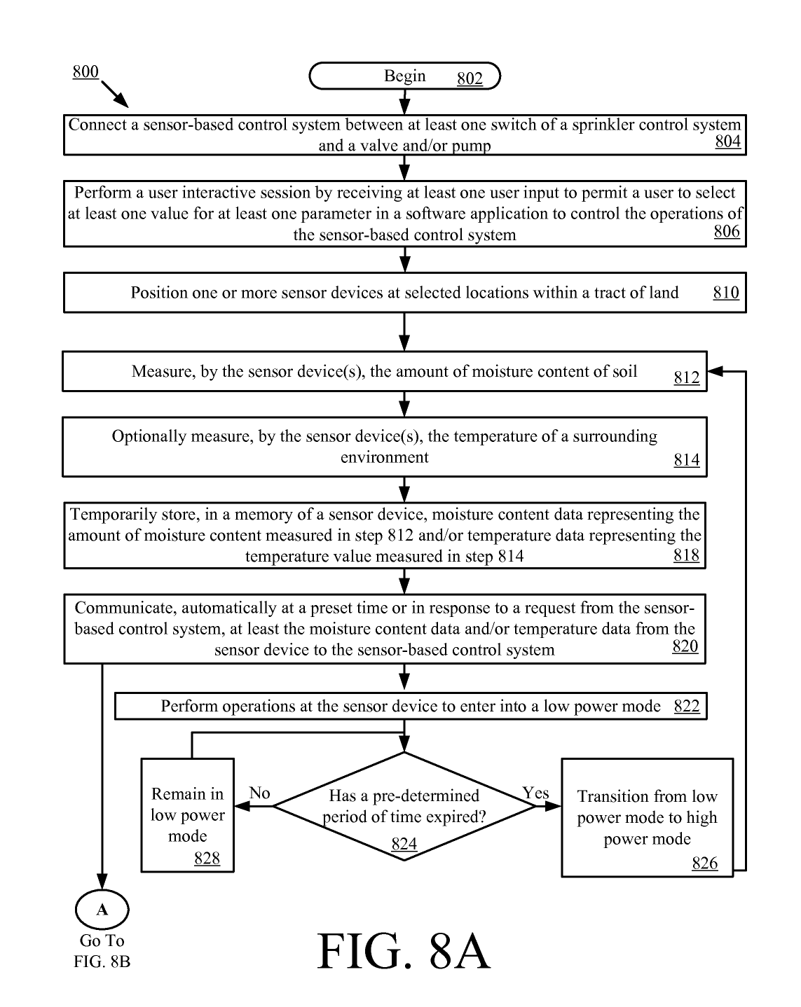

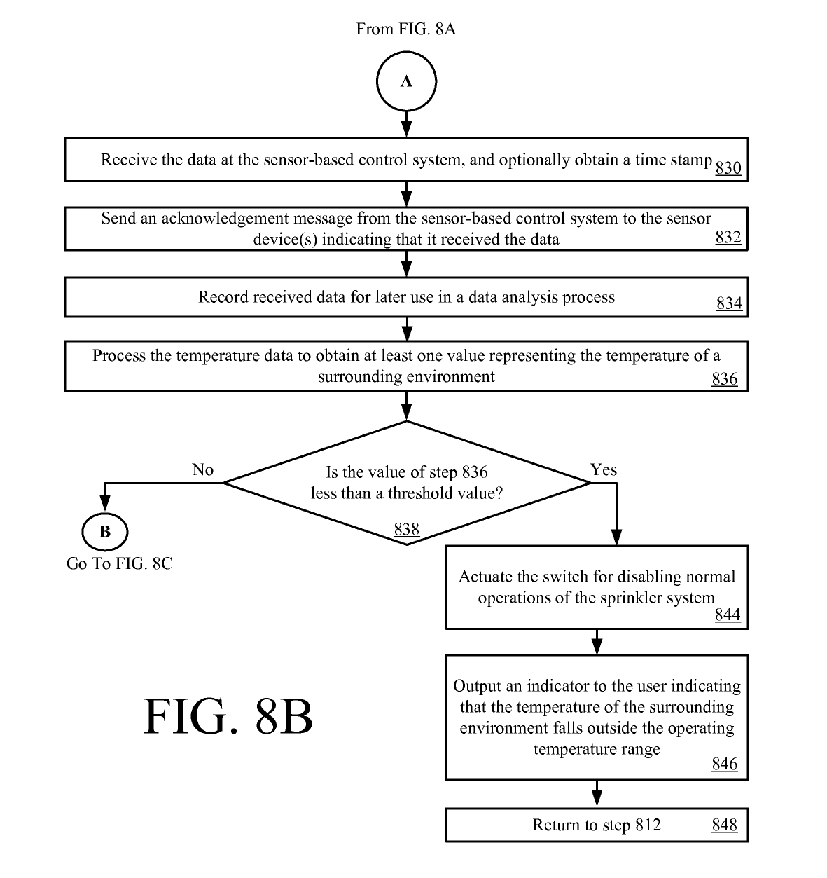

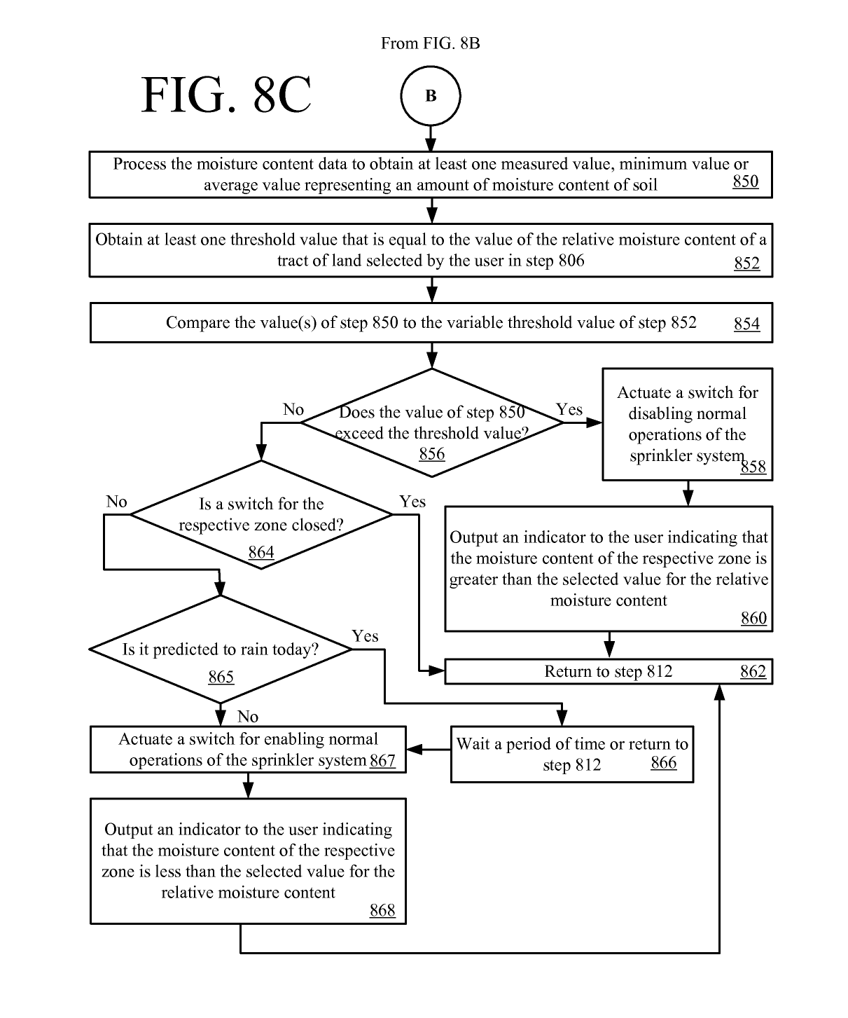

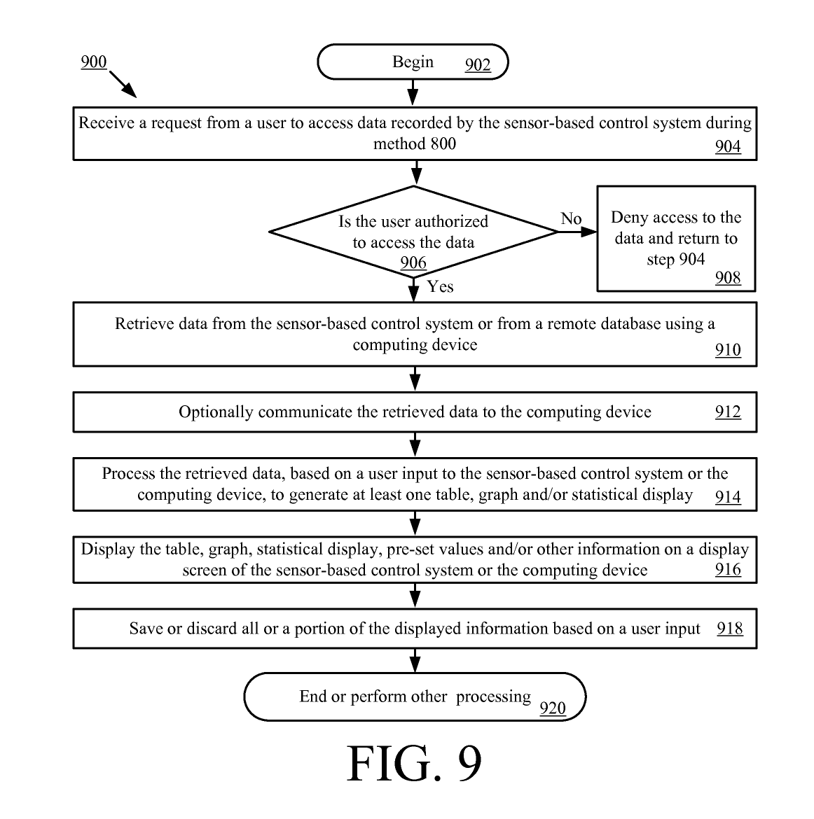

Embodiments of the present invention generally concern implementing systems and methods for controlling a sprinkler system. Exemplary systems of the present invention will be described in detail below in relation to FIGS. 1A-7. Exemplary methods of the present invention will be described in detail below in relation to FIGS. 8A-9. However, prior to discussing FIGS. 1A-9, a brief discussion of embodiments of the present invention and their advantages is provided.

Embodiments of the present invention generally comprise connecting a Sensor-Based Control System (SBCS) between switches of a Sprinkler Control System (SCS) and valves of a sprinkler system. Thereafter, a user-interactive session is performed to select a threshold value for a relative moisture content parameter of a software application installed on the SBCS. The threshold value represents a desired maximum amount of moisture content of a tract of land.

The embodiments also involve measuring, by at least one sensor device, a moisture content of soil contained in the yard. Subsequent to taking measurements, the sensor device communicates measurement data to the SBCS. The data communication is preferably achieved using a wireless communications link. The measurement data includes information defining the amount of moisture content of the soil. At the SBCS, it is determined whether the amount of moisture content of the soil exceeds the threshold value. If the amount of moisture content of the soil does not exceed the threshold value, then a switch of the SBCS is closed. Consequently, normal operations of the sprinkler system are enabled. Also, an indicator is output from the SBCS indicating that the amount of moisture content of the soil does not exceed the threshold value. The indicator includes, but is not limited to, light and/or sound. If the amount of moisture content of the soil does not exceed the threshold value, then a switch of the SCBS is closed, thereby disabling normal operations of the sprinkler system.

In some embodiments, the user-interactive session is further performed to select at least one value for a temperature parameter of the software application. The value can indicate a threshold value (e.g., 32° F.). Alternatively, the values can indicate a range of temperatures in which the sprinkler system is to operate (e.g., 40° F. to 100° F.). In either scenario, the sensor device measures a temperature of a surrounding environment. Thereafter, the sensor device communicates measurement data to the SBCS. The measurement data includes information defining the temperature measured by the sensor device. At the SBCS, it is determined whether the temperature measured by the sensor device is less than a threshold value or falls within the range of temperatures. If (a) the temperature measured by the sensor device exceeds the threshold value or falls within the range of temperatures and (b) the amount of moisture content of the soil does not exceed the threshold value, then a switch of the SBCS is closed so as to enable normal operations of the sprinkler system. In contrast, if the threshold value for temperature is not satisfied or if the moisture content exceeds a threshold value, then the switch is closed to disable normal operations of the sprinkler system.

Also in some embodiments, the SBCS determines whether it is predicted to rain at a particular location. If it is predicted to rain at the particular location, then the SBCS postpones or cancels the enablement of normal operations of the sprinkler system. In this scenario, the SBCS can determine the particular location using GPS location information or information (e.g., in IP address) provided by a user during the user-interactive session.

The present invention has various advantages. For example, the present invention advantageously uses sensor devices that are less susceptible to dirt, insects and debris as compared to conventional rain sensors. The present invention also includes a controller that is operable with conventional sprinkler controllers (or timers). Also, the controller of the present invention is less expensive to install as compared to conventional controllers (such as those disclosed in Kates and Iggulden). Further, the controller has a means for facilitating the customization of parameters (e.g., a moisture content parameter and a temperature parameter) for software applications installed thereon. As such, the amount of water supplied to an area of a tract of land can be optimized for specific types of soil and/or plants.

As evident from the above discussion, the present invention can be used in a variety of applications. Such applications include, but are not limited to, golf course applications, sports field applications, residential applications, park applications, farm applications, nursery applications, military applications, cemetery applications, city municipality applications, theme park applications and other irrigation applications. The present invention will now be described in relation to FIGS. 1A-9. Specifically, exemplary systems implementing the present invention are described below in relation to FIGS. 1A-7. Exemplary methods of the present invention are described below in relation to FIGS. 8A-9.

### Exemplary System Implementing the Present Invention

Referring now to FIG. 1A, there is provided a schematic illustration of an exemplary sprinkler system 100 that is useful for understanding the present invention. The sprinkler system 100 is generally configured to facilitate the monitoring of the moisture content of soil in a tract of land (e.g., a yard) 110 and/or the temperature of a surrounding environment. As such, the sprinkler system 100 comprises a water supply 108, a pump 109, a control system 150, at least one valve 106₁, 106₂, . . . , 106_{N}, a plurality of sprinklers 116₁, 116₂, . . . , 116ₙ, 118₁, 118₂, . . . , 118ₓ, 120₁, 120₂, . . . , 120_{y}, and at least one sensor device 112₁, 112₂, . . . , 112₅.

The control system 150 is generally configured to control the operation of the sprinkler system 100. A detailed block diagram of an exemplary architecture of the control system 150 is provided in FIG. 1B. As shown in FIG. 1B, the control system 150 includes one or more power supplies 114, 175, a Sprinkler Control System (SCS) 104 and a Sensor-Based Control System (SBCS) 102.

The SCS 104 is generally configured to control the operations of the sprinkler system 100. In this regard, the SCS 104 comprises a plurality of switches 162₁, 162₂, . . . , 162_{N} coupled to a terminal of the power supply 114. Each switch is allocated to control operations of a particular zone 122, 124, 126 of the sprinkler system 100. For example, switch 162₁ comprises a control circuit for zone 122 of the sprinkler system 100. Switch 162₂ comprises a control circuit for zone 124 of the sprinkler system 100. Switch 162_{N} comprises a control circuit for zone 126 of the sprinkler system 100.

Each of the switches 162₁, 162₂, . . . , 162_{N} is normally in an open position. As such, each switch 162₁, 162₂, . . . , 162_{N} is transitioned to a closed position when the SCS 104 determines that it is time to water all or a portion of a tract of land (e.g., a yard) and/or when the SCS 104 determines that it is not raining.

According to embodiments of the present invention, the SCS 104 includes, but is not limited to, any single zone or multi-zone sprinkler control system that is known in the art. For example, the SCS 104 includes, but is not limited to, a sprinkler timer having a model number 57896 or 94881 which is available from Orbit Irrigation Products, Inc. of Bountiful, Utah. Embodiments of the present invention are not limited in this regard.

The SBCS 102 is configured to enable and disable normal operations of the sprinkler system 100. In this regard, the SBCS 102 is disposed between the switches 162₁, 162₂, . . . , 162_{N} of the SCS 104 and the valves 106₁, 106₂, . . . , 106_{N} and/or pump 109. As shown in FIG. 1B, the SBCS 102 includes a plurality of switches 1666₁, 166₂, . . . , 166_{N} for controlling when the switches 162₁, 162₂, . . . , 162_{N} of the SCS 104 are electronically connected to the valves 106₁, 106₂, . . . , 106_{N} and/or pump 109.

When the switches 166₁, 166₂, . . . , 166_{N} of the SBCS 102 are closed, normal operations of the sprinkler system are enabled. In this scenario, power can be supplied from the power supply 114 to the valves 106₁, 106₂, . . . , 106_{N} and/or pump 109. Each of the valves 106₁, 106₂, . . . , 106_{N} includes, but is not limited to, an electromechanical valve (e.g., a solenoid valve). Each of the valves 106₁, 106₂, . . . , 106_{N} is normally in a closed position. Therefore, each valve 106₁, 106₂, . . . , 106_{N} transitions to an open position in response to a signal received from the SCS 104. In this scenario, water is allowed to flow from the water supply 108 to the sprinklers 116₁, 116₂, . . . , 116ₙ, 118₁, 118₂, . . . , 118ₓ, 120₁, 120₂, . . . , 120_{y} of the respective zone(s) 122, 124, 126.

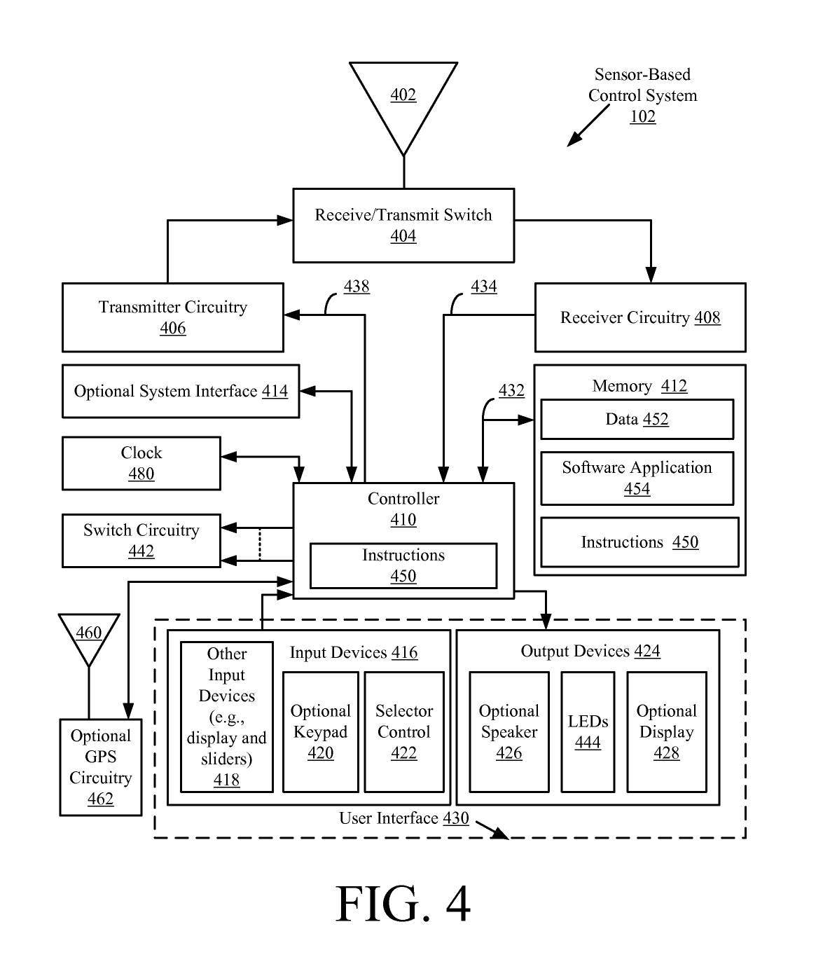

The SBCS 102 will be described in more detail below in relation to FIGS. 4-7. However, it should be understood that the SBCS 102 determines when to enable and disable normal operations of the sprinkler system 100 based on sensor information. The sensor information is obtained from one or more of the sensor devices 112₁, 112₂, . . . , 112₅. The sensor information includes, but is not limited to, moisture content information and temperature information. The SBCS 102 may also optionally disable or postpone the enablement of normal operations of the sprinkler system 100 based on weather information for a particular location. The weather information is obtained from a weather source. The weather information indicates whether or not it is predicted to rain at a particular location on a certain day. The location can be determined from Global Positioning System (GPS) location information and/or Internet Protocol (IP) address information. As should be understood, an IP address includes information identifying where a modem is located. As such, the IP address of a home computer can be used to determine an approximate location of the sprinkler system 100. The weather based feature of the present invention will become more evident as the discussion progresses.

In FIG. 1, the sensor devices 112₁, 112₂, . . . , 112₅ are disposed at least partially in the soil of one or more zones 122, 124, 126 of the tract of land 110. The depth at which the sensor devices 112₁, 112₂, . . . , 112₅ are buried in the soil depends on the particular application, as well as the manner of powering the same. For example, if a sensor device 112₁, 112₂, . . . , 112₅ is a solar powered device, then only a portion thereof is buried in the ground. In this scenario, the housing of the sensor device 112₁, 112₂, . . . , 112₅ can have a shape and size that is esthetically pleasing. Such esthetically pleasing shapes include, but are not limited to, mushroom, animals (including humans), rocks, plants and fictional characters (e.g., a leprechaun). In contrast, if the sensor device 112₁, 112₂, . . . , 112₅ is not a solar powered device, then the entire device, except for an antenna portion, may be buried in the ground. Also, the sensor device 112₁, 112₂, . . . , 112₅ can be buried to a depth that is suitable for measuring moisture content of soil of an area of a tract of land in which particular types of plants are planted.

As shown in FIG. 1A, sensor device 112₁ is disposed in zone 122. Sensor device 112₂ is disposed in zone 124. Sensor devices 112₃, 112₄, 112₅ are disposed in zone 126. At least one of the sensor devices 112₃, 112₄, 112₅ can be disposed in zone 126 at a location where the soil includes sand, and therefore retains a relatively small amount of water as compared to the soil at other locations within zone 126. Embodiments of the present invention are not limited in this regard. For example, the sensor devices 112₁, 112₂, . . . , 112₅ can be disposed at locations within the tract of land 110 that are selected in accordance with any particular application. In this regard, one or more sensor devices 112₁, 112₂, . . . , 112₅ can be disposed in each zone 122, 124, 126. Alternatively, at least one of the zones 122, 124, 126 can be absent of a sensor device. Also, the sensor devices 112₁, 112₂, . . . , 112₅ can be disposed in areas of a tract of land that have different types of soil.

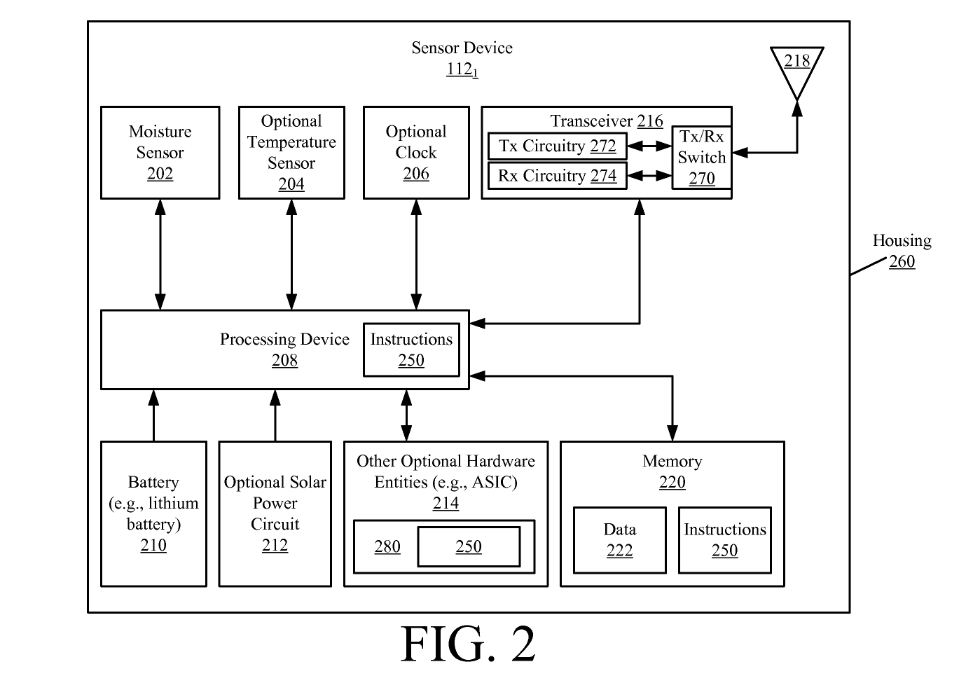

The sensor devices 112₁, 112₂, . . . , 112₅ will be described in detail below in relation to FIG. 2. However, it should be understood that the sensor devices 112₁, 112₂, . . . , 112₅ are generally configured to measure a moisture content of soil and/or a temperature of a surrounding environment. The moisture content and temperature measurements are performed by a sensor device 112₁, 112₂, . . . , 112₅ in a periodic manner. For example, a sensor device 112₁, 112₂, . . . , 112₅ measures the moisture content of soil at first preset times of a day, week, month or year. In some embodiments of the present invention, the sensor device 112₁, 112₂, . . . , 112₅ also measures the temperature of a surrounding environment at second preset times of a day, week, month or year. At least one of the first preset times can be the same as or different than at least one of the second preset times. In this regard, it should be understood that the sensor device 112₁, 112₂, . . . , 112₅ may measure the moisture content of soil more or less often than the temperature. The measurements may be performed by the sensor device 112₁, 112₂, . . . , 112₅ automatically or in response to a signal received from the SBCS 102.

After measuring the moisture content and/or temperature, a sensor device 112₁, 112₂, . . . , 112₅ can perform certain operations. These operations can include, but are not limited to, the following operations: temporarily storing data representing the measured moisture content of soil; temporarily storing data representing a measured temperature of a surrounding environment; and transmitting the data to the SBCS 102. The moisture content and temperature data is stored in the sensor device 112₁, 112₂, . . . , 112₅ in accordance with any particular format, such as a table format. In some embodiments of the present invention, the sensor device 112₁, 112₂, . . . , 112₅ also transmits an identifier to the SBCS 102. The identifier includes a sequence of number, letters and/or symbols that is unique to the sensor device 112₁, 112₂, . . . , 112₅. In this scenario, the SBCS 102 may use the identifier to determine in which zone 122, 124, 126 the sensor device 112₁, 112₂, . . . , 112₅ is located. Still, embodiments of the present invention are not limited in this regard.

At the SBCS 102, the data is recorded and processed. The data can be recorded in a memory of the SBCS 102. In some embodiments of the present invention, the data can additionally or alternatively be stored in a memory of an external device (not shown). In this scenario, the data is communicated from the SBCS 102 to an external device (not shown) via an interface. The external device includes, but is not limited to, a computing device and a remote database. The computing device includes, but is not limited to, a general purpose computer, a personal digital assistant, a cellular phone and a smart phone. In either scenario, the data is stored in accordance with a particular format. For example, the moisture content and temperature data is stored in a table format so as to be associated with a time stamp and/or an identifier of a sensor device. The time stamp can represent a time when the data is received by the SBCS 102 or a time when a parameter is measured by a sensor device. Embodiments of present invention are not limited in this regard.

Notably, the stored data can be accessed by a user at some future time for purposes of viewing and analyzing the same. In this regard, the SBCS 102 and/or external device (not shown) may restrict access to the stored information based on a user identifier, a password, at least one static biometric feature and/or access rights of the user or other user-authorized person. In some scenarios of the present invention, the access restriction is achieved using an authentication technique. Authentication techniques are well known to those skilled in the art, and therefore will not be described herein. Once a user has been authenticated, the SBCS 102 and/or external device (not shown) will retrieve all or a portion of the stored information from a respective memory (not shown). The retrieved information can be processed by the SBCS 102 and/or external device (not shown) for displaying one or more tables, graphs, statistical displays, preset parameter values and other information to the user. The other information can include, but is not limited to, recommendations for new parameter values. The information can be displayed to the user via a display screen of the SBCS 102 and/or external device (not shown). The tables, graphs and/or statistical displays can be stored in the memory of the SBCS 102 and/or external device (not shown). Alternatively, the tables, graphs and/or statistical displays can be discarded after the user has finished viewing the same. The display features of the present invention will become more evident as the discussion progresses.

Referring now to FIG. 2, there is provided a detailed block diagram of the sensor device 112₁. The sensor devices 112₂, 112₃, . . . , 112₅ of FIG. 1A are generally similar to the sensor device 112₁. As such, the following discussion of the sensor device 112₁ is sufficient for understanding the sensor devices 112₂, 112₃, . . . , 112₅. Notably, the sensor device 112₁ may include more or less components than those shown in FIG. 2. However, the components shown are sufficient to disclose an illustrative embodiment implementing the present invention.

The hardware architecture of FIG. 2 represents one embodiment of a representative sensor device 112₁ configured to facilitate the monitoring of moisture content of soil and/or the temperature of a surrounding environment. As such, the sensor device 112₁ implements at least a portion of a method for controlling a sprinkler system in accordance with embodiments of the present invention. Exemplary embodiments of the method will be described below in relation to FIGS. 8A-9.

As shown in FIG. 2, the sensor device 112₁ includes an antenna 218 for receiving and transmitting Radio Frequency (RF) signals. The antenna 218 is coupled to a transceiver 216. The transceiver 216 includes a receive/transmit (Rx/Tx) switch 270, transmitter (Tx) circuitry 272 and receiver (Rx) circuitry 274. The Rx/Tx switch 270 selectively coupled the antenna 218 to the Tx circuitry 272 and Rx circuitry 274 in a manner familiar to those skilled in the art.

The Rx circuitry 274 decodes the RF signals received from a SBCS (e.g., the SBCS 102 of FIG. 1) to derive information therefrom. The Rx circuitry 274 provides decoded RF signal information to a processing device 208. The processing device 208 uses the decoded RF signal information in accordance with the function(s) of the sensor device 112₁.

The processing device 208 also provides information to the Tx circuitry 272 for encoding information and/or modulating information into RF signals. Accordingly, the processing device 208 is coupled to the Tx circuitry 272. The Tx circuitry 272 communicates the RF signals to the antenna 218 for transmission to an external device (e.g., the SBCS 102 of FIG. 1).

As shown in FIG. 2, the sensor device 112₁ further includes a moisture sensor 202, an optional temperature sensor 204, an optional clock 206, a battery 210, an optional solar power circuit 212, a memory 220 and other optional hardware entities 214. The battery 210 includes any suitable battery (e.g., a lithium battery). The battery 210 is removably disposed in the housing 260 of the sensor device 112₁. Consequently, the battery 210 can be replaced with a new battery when it is appropriate. In some embodiments, the battery 210 is a rechargeable battery. In these scenarios, the battery 210 may be recharged by solar energy via the solar power circuit 212.

At least some of the hardware entities 214 perform actions involving access to and use of memory 220, which may be a random access memory (RAM) and/or any other suitable data storage device. Hardware entities 318 may also be configured for facilitating data communications. In this regard, the hardware entities 214 may include microprocessors, application specific integrated circuits (ASICs) and other hardware.

The processing device 208 can access and run sensor applications installed on the sensor device 112₁. At least one of the sensor applications is operative to perform data storage operations, data collection operations and data communication operations.

The data storage operations of the processing device 208 can include, but are not limited to, the following operations: temporarily storing, in memory 220, data 222 representing the measured moisture content of soil; and temporarily storing, in memory 220, data 222 representing a measured temperature of a surrounding environment. The data 222 is stored in memory 220 in accordance with any particular format. For example, the data 222 is stored in a table format.

The data collection operations of the processing device 208 can include, but are not limited to, the following operations: causing the moisture sensor 202 to measure a moisture content of soil; receiving information indicating the amount of moisture content measured by the moisture sensor 202; processing the information received from the moisture sensor 202 to generate binary data representing the amount of moisture content measured by the moisture sensor 202; causing the temperature sensor 204 to measure a temperature of an outside environment; receiving information indicating the temperature measured by the temperature sensor 204; and processing the information received from the temperature sensor 204 to generate binary data representing the temperature measured by the temperature sensor 204. The processing device 208 causes the sensors 202, 204 to measure a parameter at preset times and/or in response to signals received from an external device (e.g., the SBCS 102 of FIG. 1).

The data communication operations of the processing device 208 can include, but are not limited to, the following operations: wirelessly communicating data 222 to an external device (e.g., the SBCS 102 of FIG. 1); wireless communicating an identifier to the external device; and receiving signals from the external device.

As shown in FIG. 2, the hardware entities 214 can include a computer-readable storage medium 280 on which is stored one or more sets of instructions 250 (e.g., software code) configured to implement one or more of the methodologies, procedures, or functions described herein. The instructions 250 can also reside, completely or at least partially, within the memory 220 and/or within the processing device 208 during execution thereof by the sensor device 112₁. The memory 220 and the processing device 208 also can constitute machine-readable media. The term “machine-readable media”, as used here, refers to a single medium or multiple media that store the one or more sets of instructions 250. The term “machine-readable media”, as used here, also refers to any medium that is capable of storing, encoding or carrying a set of instructions 250 for execution by the sensor device 112₁ and that cause the sensor device 112₁ to perform any one or more of the methodologies of the present disclosure.

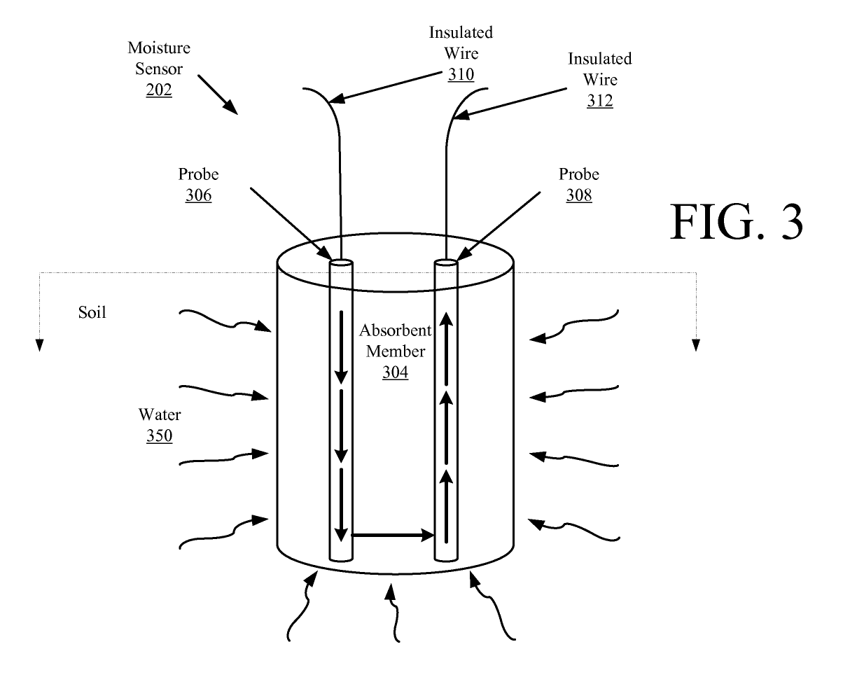

Referring now to FIG. 3, there is provided a schematic illustration of the moisture sensor 202 of FIG. 2. The moisture sensor 202 will be described in relation to a resistive moisture sensor. Still, embodiments of the present invention are not limited in this regard. For example, the moisture sensor 202 can alternatively include a capacitive moisture sensor or a thermal conductivity moisture sensor.

As shown in FIG. 3, the moisture sensor 202 includes insulated wires 310, 312, probes 306, 308 and an absorbent member 304. Each of the probes 306, 308 includes, but is not limited to, a conductive metal rod or electrode. The absorbent member 304 is provided to prevent salt and other contaminates from directly contacting at least a portion of the probes 306, 308. In this way, the life span of the probes 306, 308 is prolonged, i.e., the probes 306, 308 do not rust or corrode for a relatively longer period of time as compared to probes not partially encased by the absorbent member 304. The absorbent member 304 includes, but is not limited to, gypsum plaster, gypsum or other materials that absorbs water.

During operation, a potential difference (e.g., +3 Volts) is applied across the insulated wires 310, 312 by the processing device 208. If water has been absorbed by the absorbent member 304, there will be a current flow between probe 306 and probe 308. At the processing device 208, the current flow is measured. For example, current flow can be measured by evaluating a voltage across a resister through which the current is passed. A high voltage value (e.g., 3 Volts) indicates good electrical conductivity of the sensor (i.e., the soil has a high moisture content). A low voltage value (e.g., 1 Volts) indicates poor electrical conductivity of the sensor (i.e., the soil has a low moisture content). A voltage value equal to zero (0) volts indicates that the sensor has no electrical conductivity (i.e., the soil has no moisture content). The measured voltage value can be converted to a binary representation.

Referring now to FIG. 4, there is provided a detailed block diagram of the SBCS 102 of FIGS. 1A-1B. The SBCS 102 is generally configured to facilitate the control of a sprinkler system based at least on sensor data. As such, the SBCS 102 implements at least a portion of a method for controlling a sprinkler system in accordance with embodiments of the present invention. Exemplary embodiments of the method will be described below in relation to FIGS. 8A-9.

As shown in FIG. 4, the SBCS 102 includes an antenna 402 for receiving and transmitting Radio Frequency (RF) signals. A receive/transmit (Rx/Tx) switch 404 selectively couples the antenna 402 to the transmitter (Tx) circuitry 406 and receiver (Rx) circuitry 408 in a manner familiar to those skilled in the art. The Rx circuitry 408 demodulates and decodes the RF signals received from an external device (e.g., a sensor device 112₁, . . . , 112₅ of FIG. 1) to derive information therefrom. The Rx circuitry 408 is coupled to a controller (or microprocessor) 410 via an electrical connection 434. The Rx circuitry 408 provides the decoded RF signal information to the controller 410. The controller 410 uses the decoded RF signal information in accordance with the function(s) of the SBCS 102.

The controller 410 also provides information to the Tx circuitry 406 for encoding and modulating information into RF signals. Accordingly, the controller 410 is coupled to the Tx circuitry 406 via an electrical connection 438. The Tx circuitry 406 communicates the RF signals to the antenna 402 for transmission to an external device (e.g., a sensor device 112₁, . . . , 112₅ of FIG. 1) via the Rx/Tx switch 404.

An optional antenna 460 is coupled to optional GPS circuitry 462 for receiving GPS signals. The GPS circuitry 462 demodulates and decodes GPS signals to extract GPS location information therefrom. The GPS location information indicates the location of the SBCS 102. The GPS circuitry 462 provides the decoded GPS location information to the controller 410. The controller 410 can use the decoded GPS location information in accordance with the function(s) of the SBCS 102. For example, the GPS location information can be used to retrieve weather information for the GPS location from a weather source. The weather information indicates whether or not it is predicted to rain at the GPS location on a particular day. As noted above, location information contained in an IP address can also be used by the SBCS 102 to retrieve weather information for that location. The IP address can be supplied to the SBCS 102 by a user using the user interface 430 described below.

The controller 410 stores the decoded RF signal information and the decoded GPS location information in a memory 412 of the SBCS 102. Accordingly, the memory 412 is connected to and accessible by the controller 410 through an electrical connection 432. The memory 412 may be a volatile memory and/or a non-volatile memory. For example, the memory 412 can include, but is not limited to, a Random Access Memory (RAM), a Dynamic Random Access Memory (DRAM), a Static Random Access Memory (SRAM), Read-Only Memory (ROM) and flash memory.

As shown in FIG. 4, one or more sets of instructions 450 are stored in the memory 412. The instructions 450 include customizable and non-customizable instructions. The instructions 450 can also reside, completely or at least partially, within the controller 410 during execution thereof by the SBCS 102. In this regard, the memory 412 and the controller 410 can constitute machine-readable media. The term “machine-readable media”, as used here, refers to a single medium or multiple media that stores one or more sets of instructions 450. The term “machine-readable media”, as used here, also refers to any medium that is capable of storing, encoding or carrying the set of instructions 450 for execution by the SBCS 102 and that causes the SBCS 102 to perform one or more of the methodologies of the present disclosure.

The controller 410 is also connected to a user interface 430. The user interface 430 is comprised of input devices 416, output devices 424 and software routines (not shown in FIG. 4) configured to allow a user to interact with and control software applications (e.g., software application 454) installed on the SBCS 102. Such input and output devices include, but are not limited to, an optional display 428, an optional speaker 426, Light Emitting Diodes (LEDs) 444, an optional keypad 420, a first interface selector control (e.g., a knob) 422, a directional pad (not shown), a second interface selector control (e.g., a slider) 418 and other input devices 418. The display 428 may be designed to accept touch screen inputs.

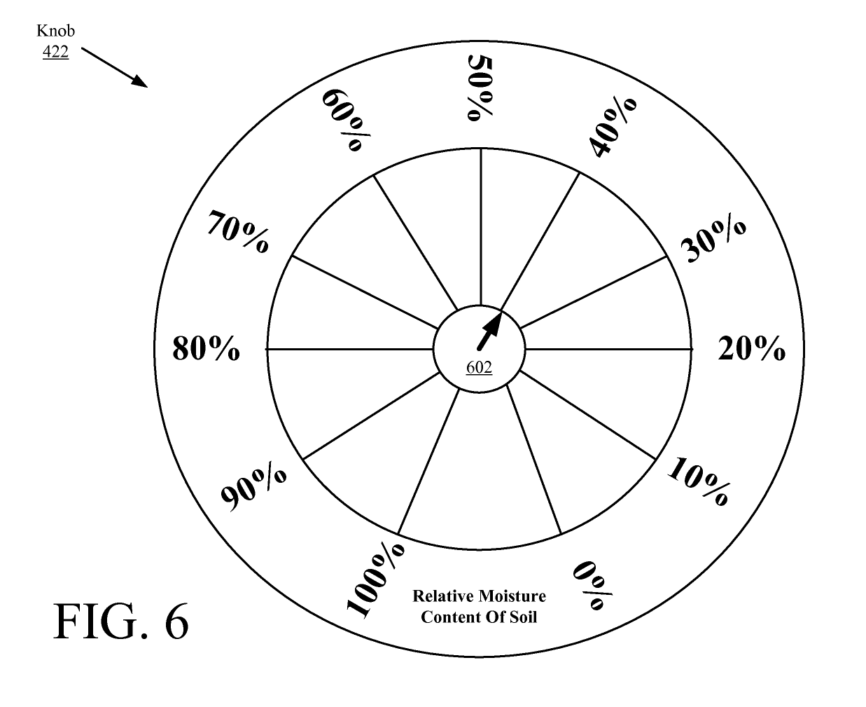

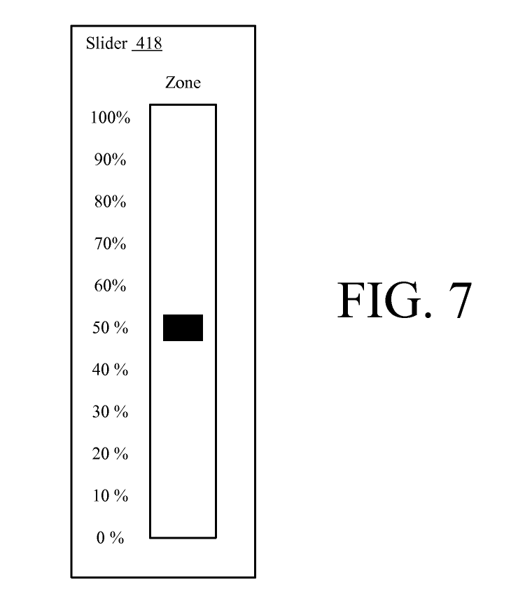

An exemplary embodiment of the first interface selector control 422 is provided in FIG. 6. As shown in FIG. 6, the first interface selector control 422 includes a rotatable member 602 that can be rotated so as to facilitate the selection of a relative moisture content of a tract of land. The relative moisture content is expressed in terms of a percentage. In a multi-zone scenario, a first interface selector control 422 can be provided for each zone (e.g., zone 122, 124 or 126 of FIG. 1). Still, embodiments of the present invention are not limited in this regard. For example, a single first interface selector control 422 can be provided for all zones (e.g., zone 122, 124 or 126 of FIG. 1A). Alternatively, a software controlled user interface (e.g., a keypad) can be provided for all zones (e.g., zone 122, 124 or 126 of FIG. 1A)

An exemplary embodiment of the second interface selector control (e.g., a slider) 418 is provided in FIG. 7. As shown in FIG. 7, the second interface selector control 418 includes an actuator 702 that is movable within a channel. The actuator 702 allows a user to set a value for a relative moisture content of a tract of land. The relative moisture content is expressed in terms of a percentage. In a multi-zone scenario, a second interface selector control 418 can be provided for each zone of a yard. Still, embodiments of the present invention are not limited in this regard. For example, a single second interface selector control 418 can be provided for all zones (e.g., zone 122, 124 or 126 of FIG. 1). Alternatively, a software controlled user interface (e.g., a keypad) can be provided for all zones (e.g., zone 122, 124 or 126 of FIG. 1A).

Referring again to FIG. 4, the user interface 430 can facilitate a user-software interaction for controlling software applications (e.g., software application 250) installed on the SBCS 102. The user interface 430 can facilitate a user-software interactive session for setting parameters of the software applications to meet their specific needs. The parameters include, but are not limited to, a relative moisture content parameter, a temperature parameter, a time parameter, a location parameter and a sensor identifier parameter. The time parameter can indicate a time when the SBCS 102 is to retrieve data from a sensor device. The time parameter can also indicate a time when a sensor device is to measure a moisture content of soil and/or a temperature. In this scenario, user-defined values for the time parameter can be communicated from the SBCS 104 to the sensor device. The user interface 430 can also facilitate accessing data 452 stored in the memory 412.

The software applications 454 facilitate the performance of data communication operations, data processing operations and sprinkler system control operations by the SBCS 102. The data communication operations include, but are not limited to, the following operations: generating RF signals; communicating RF signals to sensor devices (e.g., sensor devices 112₁, . . . , 112₅ of FIG. 1); receiving information from the sensor devices and other external devices; and communicating information to the external devices. The RF signals can include messages comprising requests for data, messages comprising acknowledgments, and messages comprising commands for causing certain operations to be performed by a particular external device. The information received at the SBCS 102 from a sensor device (e.g., sensor devices 112₁, . . . , 112₅ of FIG. 1) can include, but is not limited to, moisture content information, temperature information, optional time stamp information and sensor device identifier information. The information received at the SBCS 102 from external devices (other than the sensor devices) includes, but is not limited to, weather information for a location. The location can be determined using GPS location information and/or IP address information. The information communicated from the SBCS 102 to external devices (other than the sensor devices) includes, but is not limited to, location information, moisture content information, temperature information time stamp information and sensor device identifier information. The time stamp information can be generated by the SBCS 102 using clock 480. In this scenario, the time stamp information represents times when sensor data is received by the SBCS 102. Alternatively, the time stamp information can be generated by one or more sensor devices. In this scenario, the time stamp information represents times when one or more parameters were measured by the sensor device(s). An optional system interface 414 can be provided to facilitate the communication of information from the SBCS 102 to an external device (e.g., a computing device). The system interface 414 can be a bi-directional interface. The system interface 414 can include, but is not limited to, a Universal Serial Bus (USB) interface.

The data processing operations include, but are not limited to, the following operations: processing information received from sensor devices (e.g., sensor devices 112₁, . . . , 112₅ of FIG. 1) to determine if normal operations of the sprinkler system should be enabled or disabled; processing weather information to determine if the enablement or disablement of the sprinkler system operations should be postponed or canceled; recording and accessing data stored in memory 412 of the SBCS 102; generating displays (e.g., tables, graphs and/or statistical displays) using data received from memory 412; and discarding some or all of the displayed information.

The sprinkler system control operations can include, but are not limited to, the following operations: enabling and disabling normal operations of the sprinkler system; postponing or cancelling the enablement or disablement of the sprinkler system operations; generating signals including messages; and communicating the signals to external devices (e.g., sensor devices 112₁, . . . , 112₅ of FIG. 1).

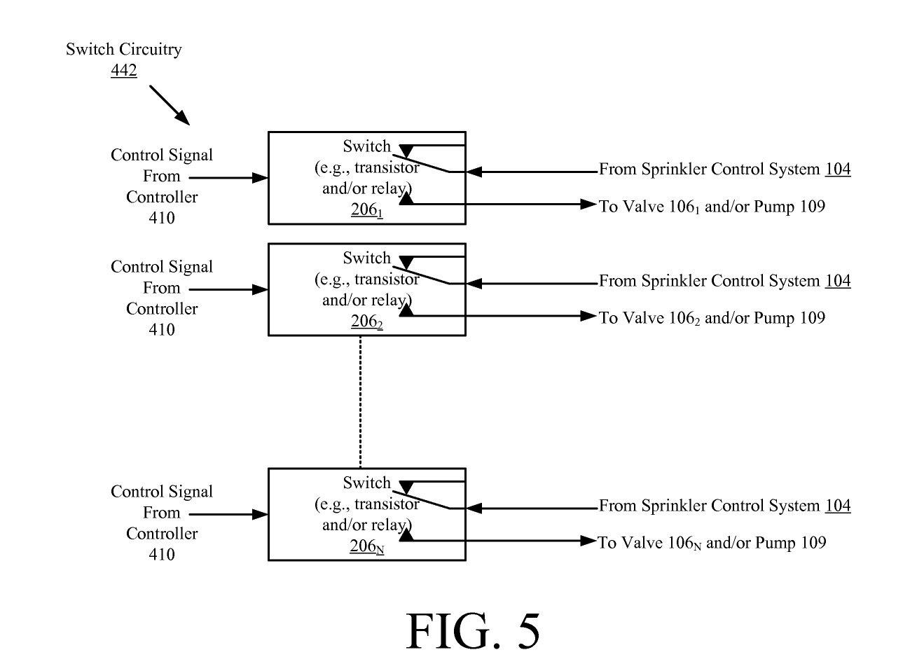

As shown in FIG. 4, the SBCS 102 includes switch circuitry 442 for facilitating the enablement and disablement of normal operations of the sprinkler system. An embodiment of the switch circuitry 442 is provided in FIG. 5. As shown in FIG. 5, the switch circuitry 442 includes a plurality of switches 206₁, 206₂, . . . , 206_{N}. Each of the switches 206₁, 206₂, . . . , 206_{N} transitions from its open position to its closed position in response to a control signal received from the controller 410. When a switch 206₁, 206₂, . . . , 206_{N} is in its closed position, the normal operations of the sprinkler system are enabled. In effect, sprinklers can be activated by the SCS 104. When a switch 206₁, 206₂, . . . , 206_{N} is in its open position, the normal operations of the sprinkler system are disabled.

### Exemplary Methods Implementing the Present Invention

Referring now to FIGS. 8A-8C, there is provided a flow diagram of an exemplary method 800 for controlling a sprinkler system that is useful for understanding the present invention. As shown in FIG. 8A, the method 800 begins with step 802 and continues to step 804. In step 804, an SBCS (e.g., the SBCS 102 of FIG. 1) is connected between at least one switch (e.g., switch 206₁, 206₂, . . . , 206_{N} of FIG. 1B) of an SCS (e.g., SCS 104 of FIGS. 1A-1B) and a valve (e.g., value 106₁, 106₂, . . . , 106_{N} of FIG. 1A). In this scenario, the SBCS can be used to enable and disable normal operations of the sprinkler system. The manner in which the enablement and disablement is achieved will be discussed below. Notably, the operations of the sprinkler system can also be enable and disabled by controlling the activation and deactivation of a pump connected to a water supply. In this scenario, even if the valve is closed by the SCS, water will not flow to the sprinklers when the pump is not turned on. As such, the SBCS (e.g., the SBCS 102 of FIG. 1) may also be connected between at least one switch (e.g., switch 206₁, 206₂, . . . , 206_{N} of FIG. 1B) of an SCS (e.g., SCS 104 of FIGS. 1A-1B) and a pump (e.g., pump 109 of FIG. 1A).

In a next step 806, a user-interactive session is optionally performed. The user-interactive session involves receiving at least one user input selecting at least one value for at least one parameter of a software application (e.g., software application 454 of FIG. 4). The parameter can include, but is not limited to, a relative moisture content parameter, a temperature parameter, a time parameter, a location parameter and a sensor identifier parameter. The value of the parameter is input into the SBCS 102 using a user interface (e.g., user interface 430 of FIG. 4) thereof. Notably, the user-interactive session of step 806 is not required in all situations. For example, the SBCS of the present invention can automatically employ the last set-point(s) used, unless the last set-point(s) has been intentionally changed since the last time used.

The relative moisture content parameter represents the desired maximum amount of moisture content of a yard. The temperature parameter represents a threshold value (e.g., 32° F.) or a range of temperatures (e.g., 40-110° F.) in which a sprinkler system (e.g., sprinkler system 100 of FIG. 1) is to operate. The time parameter represents the time that the SBCS 102 is to request data from an external device (e.g., sensor device 112₁, . . . , 112₅ of FIG. 1). The time parameter may also represent times at which a sensor device is to measure one or more parameters. The location parameter represents the actual or approximate geographic location of the sprinkler system. The sensor identifier parameter specifies the identity of one or more sensor devices.

In step 810, the sensor device(s) 112₁, . . . , and/or 112₅ is(are) placed in a tract of land (e.g., tract of land 110 of FIG. 1A). The placement of the sensor device(s) 112₁, . . . , 112₅ is made in accordance with a particular application. For example, one or more sensor devices 112₁, . . . , 112₅ can be placed in one or more zones (e.g., zones 122, 124, 126 of FIG. 1) of the tract of land 110 and/or in different types of soil in the tract of land 110.

Although step 810 is shown to occur after steps 804-806, embodiments of the present invention are not limited in this regard. For example, step 810 can be performed before, after, simultaneously or concurrently with steps 804-806.

Upon completing step 810, step 812 is performed where the amount of moisture content of soil is measured by at least one sensor device 112₁, . . . , 112₅. The sensor device 112₁, . . . , 112₅ can also optionally measure a temperature of a surrounding environment, as shown by step 814. In a next step 818, data is temporarily stored in a memory (e.g., memory 220 of FIG. 2) of the sensor device 112₁, . . . , 112₅. The data can include, but is not limited to, the following data: moisture content data representing the amount of moisture content measured in step 814; and/or temperature data representing the temperature value measured in step 816. In some embodiments, the data can also include time stamps.

Subsequent to completion of step 818, step 820 is performed. In step 820, the sensor device 112₁, . . . , 112₅ communicates data to the SBCS 102. The data communications are performed using a wireless communications links or a wired communications link. The data of step 820 can include, but is not limited to, all or a portion of the data stored in step 718 and a unique identifier for the sensor device 112₁, . . . , 112₅. The data can be communicated from the sensor device 112₁, . . . , 112₅ at a preset time or in response to a signal received from the SBCS 102.

Once the data has been communicated from the sensor device 112₁, . . . , 112₅, the method 800 continues with step 830 of FIG. 8B and steps 822-826 of FIG. 8A. Step 830 will be described below. Step 822 generally involves performing operations at the sensor device 112₁, . . . , 112₅ to enter into a low power mode. In the low power mode, a voltage applied to one or more sensors (e.g., the moisture sensor 202 and/or the temperature sensor 204 of FIG. 2) is removed. Thereafter, a decision is made as to whether a pre-determined period of time has expired. If the pre-determined period of time has not expired [824:NO], then step 828 is performed where sensor device 112₁, . . . , 112₅ remains in low power mode and returns to step 824. However, if the pre-determined period of time has expired [824:YES], then the method 800 continues with step 826. In step 826, the sensor device 112₁, . . . , 112₅ transitions from low power mode to high power mode. The mode transition is performed by the sensor device 112₁, . . . , 112₅ automatically or in response to a message (e.g., an acknowledgment message or command message) received from the SBCS 102. In high power mode, a voltage is applied to one or more sensors 202, 204.

Referring now to FIG. 8B, step 830 involves receiving data transmitted from the sensor device 112₁, . . . , 112₅ at the SBCS 102. The data can include, but is not limited to, all or a portion of the data stored in step 818 and a unique identifier for the sensor device 112₁, . . . , 112₅. Step 830 can also involve obtaining a time stamp representing the time that the data is received by the SBCS 102.

After receiving the data, the SBCS 102 sends an acknowledgement message in step 832 to the sensor device 112₁, . . . , 112₅. The acknowledgement message indicates that the SBCS 102 received the data. The acknowledgement message may also indicate that the data is error free. As shown by step 834, the SBCS 102 also records the received data so that is can be used in a later data analysis process. An exemplary data analysis process with be described below in relation to FIG. 9.

In step 836, the SBCS 102 processes the temperature data to obtain at least one value representing the temperature of a surrounding environment. In this regard, it should be understood that step 836 may involve selecting a minimum temperature value from a plurality of temperature values measured by one or more sensor devices. Thereafter, the SBCS 102 determines if the value of step 836 is less than a threshold value. The threshold value can include, but is not limited to, a threshold value pre-selected by a manufacturer or a threshold value selected by the user during the user-interactive session of step 806. Embodiments of the present invention are not limited in this regard. For example, step 838 can alternatively involve determining if the value of step 836 falls within a range of a temperatures (e.g., 40-110° F.) in which a sprinkler system (e.g., sprinkler system 100 of FIG. 1) is to operate. The range of temperatures can include, but are not limited to, a range of temperatures pre-selected by a manufacturer or a range of temperatures selected by the user during the user-interactive session of step 806.

If the value of step 836 exceeds the threshold value [838:NO], then the method 800 continues with step 850 of FIG. 8C. Step 850 will be discussed below. If the value of step 836 does not exceed the threshold value [838:YES], then the method 800 continues with step 844. In step 844, the SBCS 102 opens one or more switches 206₁, . . . , 206_{N} for disabling normal operations of the sprinkler system. When the switch is open, an electrical connection between the SCS 104 and at least one valve 106₁, . . . , 106_{N} is broken. Additionally, and electrical connection between the SCS 104 and a pump 109 may be broken.

In step 846, the SBCS 102 outputs an indicator (e.g., light, sound, icon and/or image) to a user. The indicator indicates that the moisture content of the respective zone is less than a threshold value for the relative moisture content. Subsequently, the method 800 returns to step 812, as shown by step 848.

Referring now to FIG. 8C, step 850 involves processing moisture content data to obtain one or more measured values received from one or more sensor devices. Each measured value represents the amount of moisture content of soil. Step 850 can further involve: selecting a minimum value of a plurality of values representing the amount of moisture content of soil measured by one or more sensor devices; and/or computing an average value of the plurality of values. Next in step 852, the SBCS 102 obtains one or more threshold values. Each threshold value has a value equal to the value of the relative moisture content selected by the user during the user-interactive session of step 806. Thereafter, step 854 is performed where the threshold value(s) is(are) compared to the measured value(s), minimum value or average value obtained in step 850.

If the value of step 850 exceeds the threshold value [856:YES], then the method 800 continues with steps 858-862. In step 858, the SBCS 102 opens a switch 206₁, 206₂, . . . , 206_{N} for disabling normal operations of the sprinkler system. In step 860, the SBCS 102 also outputs an indicator (e.g., light, sound, icon and/or image) indicating that the moisture content of the respective zone is greater than the value selected for the relative moisture content. Thereafter, the method 800 returns to step 812 as shown be step 862.

If the value of step 850 does not exceed the threshold value [856:NO], then the method 800 continues with steps 862-868. Step 864 involves determining if a switch 206₁, 206₂, . . . , 206_{N} for the respective zone is closed. If the switch 206₁, 206₂, . . . , 206_{N} is closed [864:YES], then the method 800 returns to step 812 as shown by step 862. If the switch 206₁, 206₂, . . . , 206_{N} is open [864:NO], then the method 800 continues with a decision step 865. In step 865, it is determined if it is predicted to rain today. This decision can be based on weather information received from a weather source. The weather information can be for a particular location specified by the SBCS 102. As noted above, the location can be determined by the SBCS 102 based on GPS location information, zip code and/or IP address information.

If it is not predicted to rain today [865:NO], then the method 800 continues with step 867. In step 867, the SBCS 102 performs actions to close a switch 206₁, 206₂, . . . , 206_{N}. In this scenario, normal operations of the sprinkler system are enabled. As such, the sprinklers of the respective zone of the yard 110 can be activated by the SCS 104. Also in step 868, the SBCS 102 outputs an indicator (e.g., light, sound, icon and/or image) to the user. The indicator indicates that the moisture content of the soil is less than the selected value for the relative moisture content.

If it is predicted to rain today [865:YES], then the method 800 continues with an optional step 866. In optional step 866, the SBCS 102 performs actions to disable or postpone the enablement of the sprinkler system operations. The postponement is achieved simply by waiting a period of time prior to performing steps 867-868. The disablement is achieved by returning to step 812. Optional step 866 ensures that the sprinkler system will not operate when it is predicted to rain. Consequently, natural resources (e.g., water and electricity) are not wasted due to overwatering. Also, fungus and certain weeds are not promoted by overwatering. Further, the nutrients of the soil of the tract of land will not be affected by overwatering.

Referring now to FIG. 9, there is provided an exemplary method 900 for accessing and analyzing data recorded by a sensor-based control system that is useful for understanding the present invention. The method 900 begins with step 902 and continues with step 904. In step 904, a request to access stored data is received at a device (e.g., the SBCS 102 and/or other computing device). The stored data includes data recorded by the SBCS 102 during method 800 described above.

In response to the request, step 906 is performed where the device 102 determines if the user is authorized to access the stored data. If the user is not authorized to access the data [906:NO], then the request is denied in step 908. Also, the method 900 returns to step 904. However, if the user is authorized to access the stored data [906:YES], then step 910 is performed where the data is retrieved from a memory. The memory can include, but is not limited to, the memory 412 of FIG. 4 and/or a remote memory (e.g., a database).

Thereafter, steps 912-920 are performed. In optional step 912, the retrieved data is communicated from the SBCS 102 to the computing device. In step 914, the retrieved data is processed at the SBCS 102 or computing device (e.g., a smart phone) to generate one or more tables, graphs, and/or statistical displays. Step 914 can also involve determining recommended parameter values which can be used by a user to optimize the operations of the SMCS 102. In step 916, the table(s), graph(s) and/or statistical displays are displayed on the SBCS 102 or computing device. Other information may also be displayed in step 916. Such other information can include, but is not limited to, recommended parameter values and previously set values for parameters. In step 918, all or a portion of the displayed information is saved or discarded based on a user input and/or a user-defined setting of a customizable software application (e.g., a smart phone application). Upon completing step 918, step 920 is performed where the method 900 ends or other processing is performed.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for controlling a sprinkler system, comprising:
connecting a Sensor-Based Control System (SBCS) between at least one switch of an output of a Sprinkler Control System (SCS) and at least one actuator positioned within a tract of land, the actuator being one of a valve and a pump;
selecting a first threshold value for a relative moisture content parameter of a software application installed on the SBCS, the first threshold value representing a moisture content above which it is not desired to water the tract of land;
measuring, by at least one sensor device, a moisture content of soil contained in the tract of land;
communicating measurement data from the sensor device to the SBCS, the measurement data including information representing an amount of moisture content of the soil measured by the sensor device;
determining, at the SBCS, whether the amount of moisture content of the soil exceeds the first threshold value;
enabling watering of the tract of land if the amount of moisture content of the soil is less than the first threshold value; and
disabling an electrical connection between the switch of the SCS and the actuator if the amount of moisture content of the soil exceeds the first threshold value.

2. The method according to claim 1, further comprising outputting an indicator from the SBCS indicating that the amount of moisture content of the soil exceeds or does not exceed the first threshold value.

3. The method of claim 1, further comprising selecting at least one value for a temperature parameter of the software application, the value representing a minimum temperature or a maximum temperature at which the sprinkler system is to operate.

4. The method according to claim 1, further comprising:
measuring a temperature of a surrounding environment; and
communicating the temperature measured to the SBCS.

5. The method according to claim 4, further comprising determining, at the SBCS, whether the temperature measured exceeds a second threshold value.

6. The method according to claim 5, further comprising establishing an electrical connection between the switch of the SCS and the actuator if (a) the temperature measured by the sensor device exceeds the second threshold value or falls within the range of temperatures, and (b) the amount of moisture content of the soil does not exceed the first threshold value.

7. The method according to claim 1, further comprising performing operations at the SBCS to determine if it is predicted to rain at a particular location on a certain day.

8. The method according to claim 7, further comprising disabling the establishment of the electrical connection if it is predicted to rain at the particular location on a certain day.

9. The method according to claim 7, further comprising performing operations at the SBCS to determine the particular location of the SBCS.

10. The method according to claim 9, wherein the particular location of the SBCS is determined using an IP address, a zip code or GPS location information.

11. A sprinkler system, comprising:
at least one power source;
a plurality of sprinklers disposed in a tract of land;
a Sprinkler Control System (SCS) configured to control at least one actuator for activating and deactivating the plurality of sprinklers, the actuator being one of a valve and a pump;
at least one sensor device disposed in the tract of land and configured to measure a moisture content of soil; and
a Sensor-Based Control System (SBCS) connected between an output of the SCS and the actuator, the SBCS comprising a machine-readable medium having stored thereon instructions, which when executed by the SBCS, cause the SBCS to perform the following operations comprising:
selecting a first threshold value for a relative moisture content parameter of a software application installed on the SBCS, the first threshold value representing a moisture content above which it is not desired to water the tract of land;
receiving, from the sensor device, measurement data including information representing an amount of moisture content of the soil measured by the sensor device;
determining whether the amount of moisture content of the soil exceeds the first threshold value;
enabling watering of the tract of land if the amount of moisture content of the soil is less than the first threshold value; and
disabling an electrical connection between the SCS and the actuator if the amount of moisture content of the soil exceeds the first threshold value.

12. The sprinkler system according to claim 11, wherein the SBCS is further caused to output an indicator indicating that the amount of moisture content of the soil exceeds or does not exceed the first threshold value.

13. The sprinkler system according to claim 11, wherein the SBCS is further caused to select at least one value for a temperature parameter of the software application, the value representing a minimum temperature or a maximum temperature at which the sprinkler system is to operate.

14. The sprinkler system according to claim 11, wherein the sensor device is further configured to measure a temperature of a surrounding environment, and communicate information defining the temperature measured thereby to the SBCS.

15. The sprinkler system according to claim 14, wherein the SBCS is further caused to determine whether the temperature measured exceeds a second threshold value.

16. The sprinkler system according to claim 15, wherein the SBCS is further caused to establish an electrical connections between the SCS and the actuator if (a) the temperature measured by the sensor device exceeds the second threshold value or falls within the range of temperatures, and (b) the amount of moisture content of the soil does not exceed the first threshold value.

17. The sprinkler system according to claim 11, wherein the SBCS is further caused to determine if it is predicted to rain at a particular location on a certain day.

18. The sprinkler system according to claim 17, wherein the SBCS is further caused to disable the establishment of the electrical connection if it is predicted to rain at the particular location on a certain day.

19. The sprinkler system according to claim 17, wherein the SBCS is further caused to determine the particular location thereof.

20. The sprinkler system according to claim 19, wherein the particular location is determined using an IP address, a zip code or GPS location information.
